(19) United States
(12) Patent Application Publication
(10) Pub. No.: US 2014/0042979 A1
(43) Pub. Date: Feb. 13, 2014

(54) CHARGE/DISCHARGE CONTROL DEVICE FOR MOLTEN SALT BATTERY AND METHOD OF CHARGING MOLTEN SALT BATTERY

(71) Applicants: Shoichiro Sakai, Osaka-shi (JP); Atsushi Fukunaga, Osaka-shi (JP); Koji Nitta, Osaka-shi (JP); Shinji Inazawa, Osaka-shi (JP)

(72) Inventors: Shoichiro Sakai, Osaka-shi (JP); Atsushi Fukunaga, Osaka-shi (JP); Koji Nitta, Osaka-shi (JP); Shinji Inazawa, Osaka-shi (JP)

(73) Assignee: SUMITOMO ELECTRIC INDUSTRIES, LTD., Osaka-shi, Osaka (JP)

(21) Appl. No.: 14/001,040

(22) PCT Filed: Feb. 15, 2012
(86) PCT No.: PCT/JP2012/053494

§ 371 Date: Oct. 28, 2013

(30) Foreign Application Priority Data
Feb. 22, 2011 (JP) 2011-035547
Jan. 11, 2012 (JP) 2012-003487

(51) Int. Cl. H02J 7/00

(52) U.S. Cl. CPC H02J 7/007
USPC 320/134; 320/150

(57) ABSTRACT

Provided is a charge/discharge control device 1 for controlling charge and discharge of a molten salt battery 2 containing molten salt as an electrolyte, the device including: a temperature sensor 12 configured to measure a temperature of the molten salt battery 2; and a control unit 13 configured to control a current value for charge and discharge such that when the temperature measured by the temperature sensor 12 is equal to or lower than a predetermined temperature, the current value for charge and discharge decreases as the measured temperature becomes lower, the predetermined temperature being higher than a melting point of the molten salt.

### TECHNICAL FIELD

The present invention relates to a charge/discharge control device for controlling charge and discharge of a molten salt battery and a method of charging the molten salt battery.

### BACKGROUND ART

### Background Art 1

In recent years, there is a growing need for secondary batteries as a power source for driving electric vehicles such as hybrid vehicles and electric cars. As a secondary battery that accommodates this purpose, a high energy density and high capacity molten salt battery has been gaining attention. This molten salt battery uses molten salt as an electrolyte, and is capable of being charged and discharged by melting the molten salt at a predetermined temperature (see Patent Literature 1, for example).

### Background Art 2

In recent years, as a high energy density and high capacity secondary battery, a lithium secondary battery and a molten salt battery have been gaining attention. The molten salt battery uses molten salt as an electrolyte, and is charged and discharged by melting the molten salt. Therefore, the conventional molten salt battery is used within a temperature range from 57° C. (a melting point of the molten salt) or higher to 190° C. (a temperature at which the molten salt is thermally decomposed) or lower (see Non-Patent Literature 1, for example).

### CITATION LIST

### Patent Literature

Patent Literature 1: Japanese Unexamined Patent Publication No. 8-138732

### Non-Patent Literature

Non-Patent Literature 1: “Molten Salt Electrolyte Battery” SEI WORLD Vol. 402, Sumitomo Electric Industries, Ltd. (March, 2011)

### SUMMARY OF INVENTION

### Technical Problems

<Problem 1>

Regarding <BACKGROUND ART 1>, the molten salt battery has a characteristic that its internal resistance increases when its temperature falls. Accordingly, when the molten salt battery is charged under low temperature, a voltage drop (IR drop) is produced due to the internal resistance, and therefore a problem that an energy loss increases occurs. In addition, when the molten salt battery is discharged under low temperature, the voltage drops if a high current is supplied, and therefore a problem that it is not possible to achieve a necessary voltage occurs.

The present invention has been made in view of the <PROBLEM 1>, and aims to provide a charge/discharge control device for a molten salt battery, the device capable of suppressing an energy loss during charge and securing a necessary voltage during discharge under low temperature.

<Problem 2>

Regarding <BACKGROUND ART 2>, in a secondary battery that uses alkali ions such as lithium or sodium as conductive ions, storing alkali ions in a state of an alkali metal in a negative electrode during charge is one method that allows high capacity density.

However, in a lithium secondary battery, so-called dendritic growth in which a lithium metal grows dendritically occurs during charge, and this becomes a cause of a short-circuit between a positive electrode and a negative electrode or of low charge and discharge efficiency, and therefore storing in a state of metal is not achieved.

Also in the molten salt battery, when charged in the temperature range, there is a case in which dendritic growth occurs by metallic sodium being deposited on a surface of the negative electrode. In this case, since a phenomenon that metallic sodium grows dendritically on the surface of the negative electrode and then falls is repeated as charge and discharge of the molten salt battery are repeated, there is a problem that a cycle characteristic of charge and discharge deteriorates.

The present invention has been made in view of the <PROBLEM 2>, and aims to provide a method of charging the molten salt battery capable of preventing the cycle characteristic of charge and discharge from being deteriorated.

### Solution To Problems

(1-1) In order to solve the <PROBLEM 1>, a charge/discharge control device for a molten salt battery according to the present invention is a charge/discharge control device for controlling charge and discharge of a molten salt battery containing molten salt as an electrolyte, the device including: a temperature measurement unit configured to measure a temperature of the molten salt battery; and a control unit configured to control a current value for charge and discharge such that when the temperature measured by the temperature measurement unit is equal to or lower than a predetermined temperature, the current value for charge and discharge decreases as the measured temperature becomes lower, the predetermined temperature being higher than a melting point of the molten salt.

According to the present invention, as the current value during charge may be reduced when the temperature of the molten salt battery falls, it is possible to reduce the voltage drop due to the internal resistance of the molten salt battery. Therefore, it is possible to suppress the energy loss when charged under low temperature.

Further, as the current value during discharge may also be reduced when the temperature of the molten salt battery falls, it is possible to prevent the voltage drop during discharge. Therefore, it is possible to secure a necessary voltage when discharged under low temperature.

(1-2) It is preferable that the control unit control the current value for charge and discharge to be a current value previously determined in association with the temperature of the molten salt battery.

In this case, it is possible to facilitate the control of the current value by the control unit, and to suitably control charge and discharge of the molten salt battery.

(1-3) It is preferable that the control unit stop current supply for charge and discharge, when the temperature measured by the temperature measurement unit is lower than the melting point of the molten salt.

In this case, it is possible to prevent the molten salt battery 2 from being charged and discharged in a state below the melting point in which conductive property is not present.

(2-1) In order to solve the <PROBLEM 2>, a method of charging a molten salt battery according to the present invention is a method of charging a molten salt battery containing molten salt as an electrolyte and having metallic sodium deposited on a negative electrode during charge, the method including: charging the molten salt battery at a predetermined temperature of 80° C. or higher and lower than 98° C.

According to the present invention, by charging the molten salt battery at the predetermined temperature of 80° C. or higher and lower than 98° C., it is possible to prevent metallic sodium deposited on the negative electrode of the molten salt battery from dendritically growing and falling, and thus deterioration of the cycle characteristic of charge and discharge may be prevented.

Specifically, as a result of intensive study, the inventors of the present invention have found that the temperature of the molten salt battery during charge is a factor most dominating on the phenomenon of dendritic growth and falling of metallic sodium deposited on the negative electrode, and that the falling of metallic sodium may be suppressed by keeping the temperature during charge to be within a predetermined range, and have completed the present invention based on the above findings.

(2-2) The molten salt battery is preferably configured such that the negative electrode contains metallic sodium as a negative electrode active material.

In this case, it is possible to prevent metallic sodium as a part of the negative electrode of the molten salt battery from dendritically growing and falling, and thus deterioration of the cycle characteristic of charge and discharge may be prevented.

(2-3) The molten salt battery is preferably configured such that a current value during charge is controlled according to the predetermined temperature.

In this case, by controlling the current value during charge according to the predetermined temperature, a deposition rate of sodium metal during charge and the dendritic growth affected by the hardness of the sodium metal at the predetermined temperature may be balanced, and thus it is possible to effectively prevent the metallic sodium from dendritically growing on the negative electrode of the molten salt battery. Accordingly, deterioration of the cycle characteristic of charge and discharge may be prevented.

### BRIEF DESCRIPTION OF DRAWINGS

FIG. 1 is a schematic configuration diagram of a charge/discharge control device for a molten salt battery according to one embodiment of the present invention in Chapter 1.

FIG. 2 is a schematic configuration diagram of the molten salt battery in Chapter 1.

FIG. 3 is a graph showing a relation between an internal resistance and a temperature of the molten salt battery in Chapter 1 and Chapter 2.

FIG. 4 is a table showing a current density previously determined in association with a temperature of the molten salt battery in Chapter 1 and Chapter 2.

FIG. 5 is a schematic configuration diagram of the molten salt battery to which a charging method according to one embodiment of the present invention in Chapter 2 is used.

FIGS. 6(a) and 6(b) show graphs showing a result of cycle evaluation of charge and discharge of the molten salt battery in Chapter 2.

FIG. 7 is a schematic configuration diagram of a charge/discharge control device for the molten salt battery in Chapter 2.

FIG. 8 is a schematic configuration diagram of the molten salt battery to which a charging method according to a different embodiment of the present invention in Chapter 2 is used.

### DESCRIPTION OF EMBODIMENTS

### Chapter 1

Hereinafter, an embodiment according to the present invention in Chapter 1 will be described with reference to the drawings.

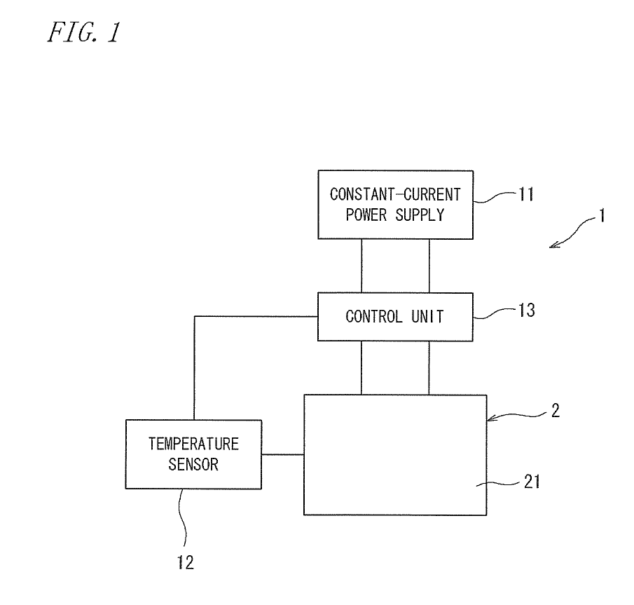

FIG. 1 is a schematic configuration diagram of a charge/discharge control device for a molten salt battery according to one embodiment of the present invention in Chapter 1.

Referring to FIG. 1, a charge/discharge control device 1 is configured to control charge and discharge of a molten salt battery 2 used in a hybrid vehicle (HEV) driven by appropriately switching between an engine and an electric motor, which are not illustrated, as a source of electrical energy of the electric motor, for example.

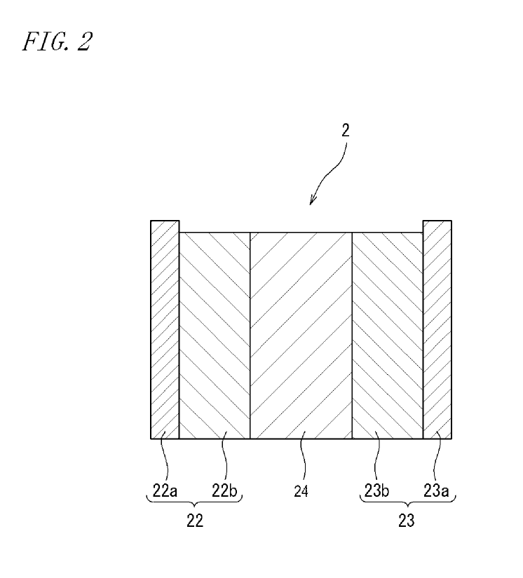

FIG. 2 is a schematic configuration diagram of the molten salt battery 2. Referring to FIG. 2, the molten salt battery 2 is configured such that a positive electrode 22, a negative electrode 23, and a separator 24 disposed between the electrodes 22 and 23 are contained within a box-shaped battery container 21 (see FIG. 1).

The positive electrode 22 includes a current collector of positive electrode 22a and a positive electrode active material layer 22b disposed within the current collector of positive electrode 22a. The current collector of positive electrode 22a is configured by a porous body of an aluminum alloy, for example, and the positive electrode active material layer 22b contains sodium chromite (NaCrO₂) as a positive electrode active material, for example.

The negative electrode 23 includes a current collector of negative electrode 23a and a negative electrode active material layer 23b disposed within the current collector of negative electrode 23a. The current collector of negative electrode 23a is configured by aluminum foil, for example, and the negative electrode active material layer 23b contains tin (Sn), for example, as a negative electrode active material.

The separator 24 is configured by a porous film of a fluorine resin having resistance to molten salt at a temperature that the molten salt battery 2 operates, and immersed in molten salt (not illustrated) filled within the battery container 21.

With the above configuration, by heating the molten salt battery 2 up to the temperature from 80° C. to 100° C. by a heater (not illustrated), the molten salt melts to allow charge and discharge.

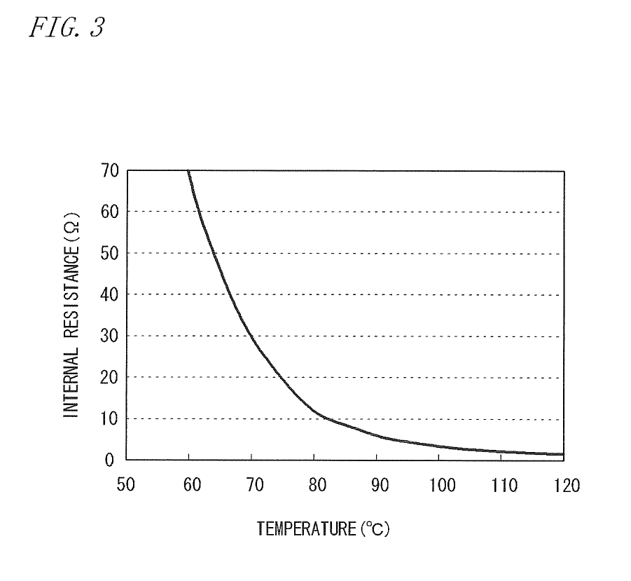

FIG. 3 is a graph showing a relation between a temperature and an internal resistance of the molten salt battery 2. As is apparent from FIG. 3, the molten salt battery 2 has a characteristic that its internal resistance excessively increases when its temperature becomes about 70° C. or lower.

It should be noted that values of the internal resistance shown in this graph are calculated according to the following equation (1), based on temperatures when a distance between the electrodes of the molten salt battery 2 (thickness of the separator 24) is 200 μm.

σ(T)=A_{σ}/SQRT(T)×exp(−B_{σ}/(T−T₀)) (1)

Here, σ is a value of the internal resistance, T is the temperature of the molten salt battery 2, A_{σ} and B_{σ} are coefficients determined depending on types of the molten salt, T₀ is the temperature at which ion transfer stops, and SQRT is an operator for calculating a square root of the value derived by a bracket expression. In the case of the molten salt battery 2 according to this embodiment, A_{σ}=1.92×10², B_{σ}=0.837×10³, and T₀=245K.

Referring to FIG. 1, the charge/discharge control device 1 is configured to control charge and discharge considering the characteristic of the molten salt battery 2, and is provided with a constant-current power supply 11 for supplying a current to the molten salt battery 2 during charge, a temperature sensor (temperature measurement unit) 12 for measuring the temperature of the molten salt battery 2, and a control unit 13 for controlling the current value for charge and discharge based on the temperature measured by the temperature sensor 12.

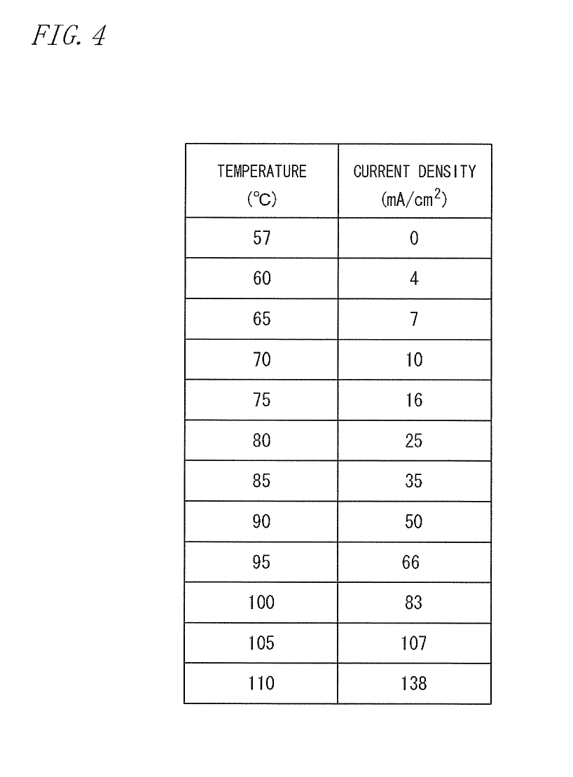

When the temperature measured by the temperature sensor 12 is 70° C. or lower, the control unit 13 controls the current value for charge and discharge to be smaller as the measured temperature is lower. As shown in FIG. 4, the current value is set to be a current density (current value) previously determined in association with the temperature of the molten salt battery 2. The current density shown in FIG. 4 is calculated according to the following equation (2), such that the IR value is constant at any temperature taking as a reference 50 mA/cm² when the temperature of the molten salt battery 2 is 90° C.

I_{T}=190×R₉₀/R_{T} (2)

Here, I_{T} is the current density, I₉₀ is the current density (=50 mA/cm²) when the temperature of the molten salt battery 2 is 90° C., R_{T} is a value of the internal resistance, and R₉₀ is a value of the internal resistance when the temperature of the molten salt battery 2 is 90° C.

As described above, when the temperature measured by the temperature sensor 12 is 70° C. or lower, the control unit 13 controls the current value for charge and discharge to be the current density previously determined in the table of FIG. 4 in association with the measured temperature. For example, when the temperature measured by the temperature sensor 12 is 60° C., the current value for charge and discharge is controlled such that the current density is 4 mA/cm² corresponding to 60° C. in the table of FIG. 4. Then, the control unit 13 is configured to stop current supply for charge and discharge when the temperature measured by the temperature sensor 12 becomes lower than 57° C., which is the melting point of the molten salt.

It should be noted that although the control unit 13 performs the control when the measured temperature is 70° C. or lower in this embodiment, the current density in the table of FIG. 4 is prepared in association with the temperature of the molten salt battery 2 up to 110° C. Therefore, a predetermined temperature at which the control unit 13 starts the control may be appropriately adjusted in a range from 70° C. to 110° C. according to the actual control for charge and discharge.

As described above, according to the charge/discharge control device 1 of the molten salt battery 2 of this embodiment, since the current value during charge may be reduced when the temperature of the molten salt battery 2 falls, it is possible to reduce the voltage drop due to the internal resistance of the molten salt battery 2. Therefore, it is possible to suppress the energy loss when charged under low temperature. Further, in a case of an electric vehicle for which time for driving a vehicle of regularly-operated buses and trains is previously determined, the molten salt battery that is not fully heated may be charged in a carbarn and the like before driving, and thus may be suitably used for such an electric vehicle.

Moreover, since the current value during discharge may also be reduced when the temperature of the molten salt battery 2 falls, it is possible to prevent the voltage drop during discharge. Therefore, it is possible to secure a necessary voltage when discharged under low temperature.

Further, since the control unit 13 controls the current value for charge and discharge to be the current density previously determined in association with the temperature of the molten salt battery 2, it is possible to facilitate the control of the current value by the control unit 13, and to suitably control charge and discharge of the molten salt battery 2.

Moreover, as the control unit 13 stops current supply for charge and discharge when the temperature measured by the temperature sensor 12 becomes lower than the melting point of the molten salt, it is possible to prevent the molten salt battery 2 from being charged and discharged in a state below the melting point in which conductive property is not present.

The embodiment disclosed in Chapter 1 is illustrative in all aspects and considered to be non-restrictive. The scope of the present invention is defined by the claims, instead of the meaning carried by the above description, and equivalence of and any modification within the scope of the claims are intended to be included therein.

For example, in the above embodiment, the control unit 13 controls the current value when the measured temperature is 70° C. or lower. However, the control unit 13 may be configured to control the current value at any measured temperature or lower excluding 70° C. as long as the temperature is higher than the melting point of the molten salt and the internal resistance becomes large.

Further, although the current density previously determined in association with the temperature of the molten salt battery 2 is calculated based on the equation (2), a different equation may be used.

Moreover, the charge/discharge control device 1 according to the present invention in Chapter 1 may also be applied to an electric vehicle such as an electric car (EV) or a train, in addition to a hybrid vehicle.

### REFERENCE SIGNS LIST

1: Charge/Discharge Control Device

2: Molten Salt Battery

12: Temperature Sensor (Temperature Measurement Unit)

13: Control Unit

### Chapter 2

Next, an embodiment according to the present invention in Chapter 2 will be described with reference to the drawings.

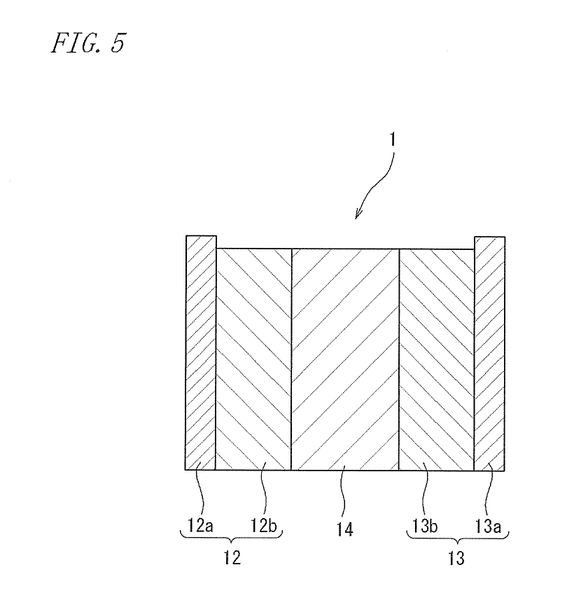

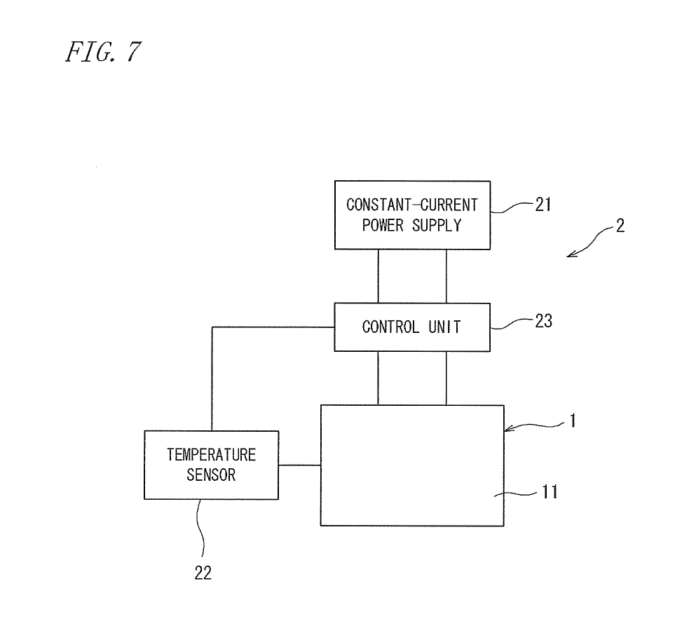

FIG. 5 is a schematic configuration diagram of the molten salt battery. Referring to FIG. 5, a molten salt battery 1 is configured such that a positive electrode 12, a negative electrode 13, and a separator 14 disposed between the electrodes 12 and 13 are contained within a box-shaped battery container 11 (see FIG. 7).

The positive electrode 12 includes a current collector of positive electrode 12a and a positive electrode active material layer 12b disposed within the current collector of positive electrode 12a. The current collector of positive electrode 12a is configured by a porous body of an aluminum alloy, for example, and the positive electrode active material layer 12b contains sodium chromite (NaCrO₂) as a positive electrode active material, for example.

The negative electrode 13 includes a current collector of negative electrode 13a and a negative electrode active material layer 13b disposed within the current collector of negative electrode 13a. The current collector of negative electrode 13a is configured by aluminum foil whose thickness is 20 μm, for example. The negative electrode active material layer 13b contains, as a negative electrode active material, metallic sodium (Na) whose thickness is from 100 μm to several mm, for example, and is fixed to the current collector of negative electrode 13a by rolling or dipping.

The separator 14 is configured by a porous film of a fluorine resin having resistance to molten salt at a temperature that the molten salt battery 1 is used, and immersed in molten salt (not illustrated) as an electrolyte filled within the battery container 11.

It is possible to charge and discharge the molten salt battery 1 by heating the molten salt battery 1 thus configured by heating means (not illustrated) such as a heater to melt the molten salt. More specifically, charge and discharge of the molten salt battery 1 is performed by the heating means heating the molten salt battery 1 up to a predetermined temperature (90° C. in this embodiment) of 80° C. or higher and 120° C. or lower, and more preferably, 80° C. or higher and lower than 98° C.

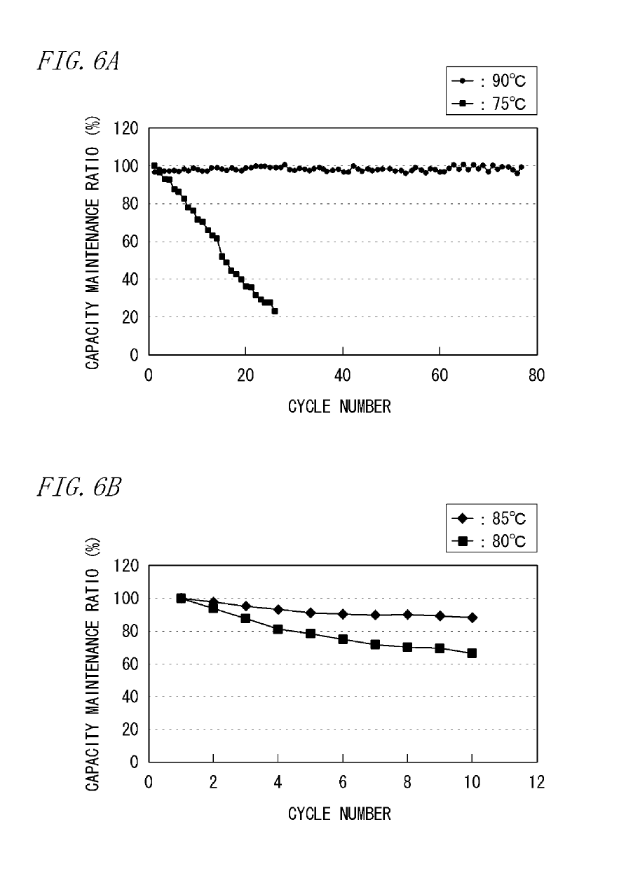

FIGS. 6(a) and FIG. 6(b) are graphs showing results of cycle evaluation of charge and discharge. The evaluation was performed using a 10 cm square positive electrode and a 10.5 cm square negative electrode having a masking over an edge and a back surface.

Referring to FIG. 6(a), when the molten salt battery 1 is charged and discharged at 75° C. which is near the melting point of the molten salt (57° C.), a capacity maintenance ratio steeply decreases as a cycle number increases. By contrast, when the molten salt battery 1 is charged and discharged at 90° C. which is the predetermined temperature, the capacity maintenance ratio is maintained substantially at 100% even if the cycle number increases.

Further, referring to FIG. 6(b), when the molten salt battery 1 is charged and discharged at 80° C. and 85° C., the capacity maintenance ratio becomes slightly lower than the case when charged and discharged at 90° C. as the cycle number increases, but decreases more moderately than the case when charged and discharged at 75° C. in FIG. 6(a), and it is possible to obtain a certain effect for suppressing the reduction of the capacity maintenance ratio.

From the above result of evaluation, it may be seen that deterioration of the cycle characteristic for charge and discharge may be prevented by charging the molten salt battery 1 at the predetermined temperature of 80° C. (more preferably, 85° C.) or higher. This is supposedly because dendritic growth and falling of metallic sodium of the negative electrode active material layer 13b deposited on a surface of the negative electrode 13 are prevented. From this, it is found that by charging the molten salt battery 1 at the predetermined temperature lower than 98° C. which is the melting point of metallic sodium, it is possible to prevent metallic sodium from falling from the negative electrode 13 by being melted, and thus deterioration of the cycle characteristic of charge and discharge may be further prevented.

FIG. 3 is a graph showing a relation between a temperature and an internal resistance of the molten salt battery 1. As is apparent from FIG. 3, the molten salt battery 1 has a characteristic that its internal resistance excessively increases as its temperature becomes lower.

It should be noted that values of the internal resistance shown in this graph are calculated according to the following equation (1), based on temperatures when a distance between the electrodes of the molten salt battery 1 (thickness of the separator 14) is 200 μm.

σ(T)=A_{σ}/SQRT(T)×exp(−B_{σ}/(T−T₀)) (1)

Here, σ is a value of the internal resistance, T is the temperature of the molten salt battery 1, A_{σ} and B_{σ} are coefficients determined depending on types of the molten salt, T₀ is the temperature at which ion transfer stops, and SQRT is an operator for calculating a square root of the value derived by a bracket expression. In the case of the molten salt battery 1 according to this embodiment, A_{σ}=1.92×10², B_{σ}=0.837×10³, and T₀=245K.

FIG. 7 is a schematic configuration diagram of a charge/discharge control device of the molten salt battery.

Referring to FIG. 7, a charge/discharge control device 2 is configured to control charge and discharge of the molten salt battery 1, and is provided with a constant-current power supply 21 for supplying a current to the molten salt battery 1 during charge, a temperature sensor (temperature measurement unit) 22 for measuring the temperature of the molten salt battery 1, and a control unit 23 for controlling the current value for charge and discharge based on the temperature measured by the temperature sensor 22.

When the temperature measured by the temperature sensor 22 is 110° C. or lower, the control unit 23 controls the current value for charge and discharge to be smaller as the measured temperature is lower. As shown in FIG. 4, the current value is set to be a current density (current value) previously determined in association with the temperature of the molten salt battery 1. The current density shown in FIG. 4 is calculated according to the following equation (2), such that the IR value is constant at any temperature taking as a reference 50 mA/cm² when the temperature of the molten salt battery 1 is 90° C.

I_{T}=I₉₀×R₉₀/R_{T} (2)

Here, I_{T} is the current density, I₉₀ is the current density (=50 mA/cm²) when the temperature of the molten salt battery 1 is 90° C., RT is a value of the internal resistance, and R₉₀ is a value of the internal resistance when the temperature of the molten salt battery 1 is 90° C.

As described above, when the measured temperature is 110° C. or lower, more preferably 80° C. or higher and lower than 98° C., the control unit 23 controls the current value for charge and discharge to be the current density previously determined in the table of FIG. 4 in association with the temperature measured by the temperature sensor 22. For example, when the temperature measured by the temperature sensor 22 is 85° C., the current value for charge and discharge is controlled such that the current density is 35 mA/cm² corresponding to 85° C. in the table of FIG. 4. Then, the control unit 23 is configured to stop current supply for charge and discharge when the temperature measured by the temperature sensor 22 becomes lower than 57° C., which is the melting point of the molten salt.

It should be noted that although the control unit 23 controls the current value when the measured temperature is 110° C. or lower, the control unit 23 may be configured to control the current value at any measured temperature or lower excluding 110° C. as long as the temperature is higher than the melting point of the molten salt and the internal resistance becomes large.

Further, although the current density previously determined in association with the temperature of the molten salt battery 1 is calculated based on the equation (2), a different equation may be used.

As described above, according to the method of charging the molten salt battery 1 of this embodiment, by charging the molten salt battery 1 at the predetermined temperature of 80° C. or higher and lower than 98° C., it is possible to prevent metallic sodium as a part of the negative electrode 13 of the molten salt battery 1 from falling, and thus deterioration of the cycle characteristic of charge and discharge may be prevented.

According to the charge/discharge control device 2 of this embodiment, as the current value during charge may be reduced when the temperature of the molten salt battery 1 falls, it is possible to reduce the voltage drop due to the internal resistance of the molten salt battery 1. Therefore, it is possible to suppress the energy loss when charged under low temperature.

Further, since the current value during discharge may also be reduced when the temperature of the molten salt battery 1 falls, it is possible to prevent the voltage drop during discharge. Therefore, it is possible to secure a necessary voltage when discharged under low temperature.

Moreover, as the control unit 23 controls the current value for charge and discharge to be the current density previously determined in association with the temperature of the molten salt battery 1, it is possible to facilitate the control of the current value by the control unit 23, and to suitably control charge and discharge of the molten salt battery 1.

Furthermore, by controlling the current value to correspond to the predetermined temperature when charging the molten salt battery 1 at the predetermined temperature, a deposition rate of sodium metal during charge and the dendritic growth affected by the hardness of the sodium metal at the predetermined temperature may be balanced. Accordingly, it is possible to effectively prevent the metallic sodium from dendritically growing on the negative electrode 13 of the molten salt battery 1, and thus deterioration of the cycle characteristic of charge and discharge may be further prevented.

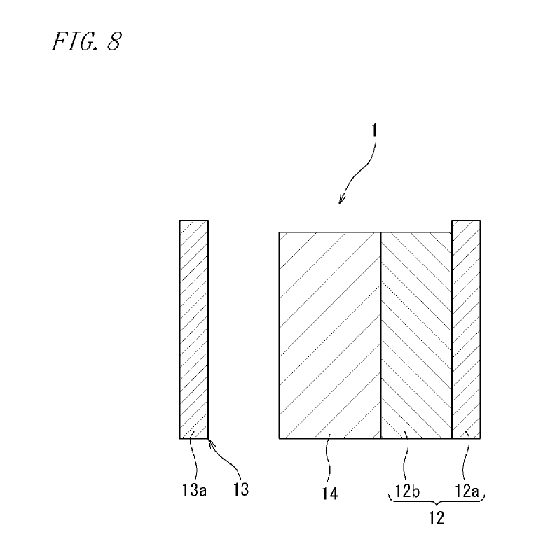

FIG. 8 is a schematic configuration diagram of a molten salt battery according to another embodiment in Chapter 2.

The embodiment illustrated in FIG. 8 is different from the embodiment illustrated in FIG. 5 in that the negative electrode 13 of the molten salt battery 1 includes only the current collector of negative electrode 13a. The current collector of negative electrode 13a is configured by performing a zincate treatment to form a thin film made of zinc over a surface of aluminum foil, for example.

According to the molten salt battery 1 of this embodiment, with metallic sodium (Na) moving from sodium chromite (NaCrO₂) contained in a positive electrode active material layer 12b on a side of the positive electrode 12 to the current collector of negative electrode 13a during charge, the metallic sodium acts as a negative electrode active material. Therefore, in order to prevent metallic sodium deposited on the negative electrode 13 from dendritically growing and falling, similarly to the embodiment described previously, the molten salt battery 1 performs charge and discharge by heating the molten salt battery 1 up to the predetermined temperature of 80° C. or higher and lower than 98° C.

As described above, also in the method of charging the molten salt battery 1 of this embodiment, by charging the molten salt battery 1 at the predetermined temperature of 80° C. or higher and lower than 98° C., it is possible to prevent metallic sodium from falling from the negative electrode 13 of the molten salt battery 1, and thus deterioration of the cycle characteristic of charge and discharge may be prevented.

The embodiment disclosed in Chapter 2 is illustrative in all aspects and considered to be non-restrictive. The scope of the present invention is defined by the claims, instead of the meaning carried by the above description, and equivalence of and any modification within the scope of the claims are intended to be included therein.

For example, although the molten salt battery according to the above embodiment uses the metallic sodium as a negative electrode active material, hard carbon or tin (Sn) may be used as the negative electrode active material. In this case, by using the charging method of the above embodiment, it is possible to prevent the metallic sodium deposited on an edge portion of the negative electrode active material layer from dendritically growing and falling during charge.

Further, although the molten salt battery is charged and discharged at 90° C. in the charging method of the above embodiment, the charge and discharge may be performed at any temperature within a range from 80° C. or higher and lower than 98° C.

### REFERENCE SIGNS LIST

1: Molten Salt Battery

13: Negative Electrode

13b: Negative Electrode Active Material Layer

1. A charge/discharge control device for controlling charge and discharge of a molten salt battery containing molten salt as an electrolyte, the device comprising:
a temperature measurement unit configured to measure a temperature of the molten salt battery; and
a control unit configured to control a current value for charge and discharge such that when the temperature measured by the temperature measurement unit is equal to or lower than a predetermined temperature, the current value for charge and discharge decreases as the measured temperature becomes lower, the predetermined temperature being higher than a melting point of the molten salt.

2. The charge/discharge control device for a molten salt battery according to claim 1, wherein
the control unit controls the current value for charge and discharge to be a current value previously determined in association with the temperature of the molten salt battery.

3. The charge/discharge control device for a molten salt battery according to claim 1, wherein
the control unit stops current supply for charge and discharge, when the temperature measured by the temperature measurement unit is lower than the melting point of the molten salt.

4. A method of charging a molten salt battery containing molten salt as an electrolyte and having metallic sodium deposited on a negative electrode during charge, the method comprising:
charging the molten salt battery at a predetermined temperature of 80° C. or higher and lower than 98° C.

5. The method of charging a molten salt battery according to claim 4, wherein
the negative electrode contains metallic sodium as a negative electrode active material.

6. The method of charging a molten salt battery according to claim 4, further comprising:
controlling a current value during charge according to the predetermined temperature.

7. The charge/discharge control device for a molten salt battery according to claim 2, wherein
the control unit stops current supply for charge and discharge, when the temperature measured by the temperature measurement unit is lower than the melting point of the molten salt.

8. The method of charging a molten salt battery according to claim 5, further comprising:
controlling a current value during charge according to the predetermined temperature.
